(19) United States
(12) Patent Application Publication
(10) Pub. No.: US 2025/0170968 A1
(43) Pub. Date: May 29, 2025

(54) SENSOR ARRANGEMENT, VEHICLE AND METHOD FOR ASSEMBLING A SENSOR ARRANGEMENT

(71) Applicant: Continental Autonomous Mobility Germany GmbH, Ingolstadt (DE)

(72) Inventors: Detlef-Leopold Neusatz, Eitensheim (DE); Mihai-Radu Jina, Orastie (RO)

(73) Assignee: Continental Autonomous Mobility Germany GmbH, Ingolstadt (DE)

(21) Appl. No.: 18/961,738

(22) Filed: Nov. 27, 2024

(30) Foreign Application Priority Data
Nov. 27, 2023 (DE) 10 2023 211 812.2

(51) Int. Cl. B60R 11/04; B60R 11/00; G01S 7/481; G01S 17/931

(52) U.S. Cl. CPC B60R 11/04; B60R 11/00; G01S 7/4813; G01S 17/931; B60R 2011/004; B60R 2011/0052; B60R 2300/301

(57) ABSTRACT

A sensor arrangement for a vehicle includes a sensor for capturing the surroundings and having a sensor housing. The arrangement also includes an arrangement housing in which the sensor is arranged. The arrangement housing is disposed in/on a vehicle roof of the vehicle. A fastening device, provided on the sensor housing, includes a first portion having a first diameter and a second portion having a second diameter. The first diameter is smaller than the second diameter. The vehicle has a receptacle for the fastening device which is embodied such that the receptacle can receive a portion having the first diameter and cannot receive a portion having the second diameter, so that the fastening apparatus engages with the first portion in the receptacle and the second portion does not engage in the receptacle in order to align the sensor on the vehicle.

### CROSS-REFERENCE TO RELATED APPLICATION

This application claims priority to German patent application No. 10 2023 211 812.2, filed Nov. 27, 2023, which is hereby incorporated by reference

### TECHNICAL FIELD

The technical field relates to a sensor arrangement for capturing surroundings of a vehicle as well as a method for assembling the sensor arrangement.

### BACKGROUND

Modern means of transportation such as motor vehicles or motorcycles are increasingly equipped with driver assistance systems which, with the aid of sensor systems, can capture the surroundings, recognize traffic situations and support the driver, e.g., by a braking or steering intervention or by outputting a visual or audible warning. Radar sensors, lidar sensors, camera sensors or the like are regularly deployed as sensor systems for capturing the surroundings. Conclusions can subsequently be drawn about the surroundings from the sensor data established by the sensors.

The process of assembling a corresponding sensor for capturing the surroundings on the vehicle plays an important part in the functionality of the sensor. Typically, the sensor is integrated, paying particular attention to aspects such as the precise alignment of the sensor, the assembly of the sensor on the body so that it is robust against vibrations, it being sealed in a watertight manner, as well as aspects such as thermal management and the repair/workshop concept (exchangeability) of the sensor. For example, radar sensors are arranged behind vehicle members (e.g., behind the radiator grill), through which the radar sensor can irradiate. Similarly, cameras or lidar sensors are frequently arranged behind the windshield. The advantage of this is that the sensor is constantly protected against penetrating moisture. Less frequently, sensors are integrated in/on the roof of a vehicle since this requires a complex assembly structure, because it is frequently difficult to seal the sensor with a watertight sealing class against the outer surroundings and, at the same time, to guarantee a complete repair concept so that the sensor can later be easily exchanged in a workshop. Further problems arise from guaranteeing a robust assembly of the sensor on the body in mechanical terms with respect to any vibrations or when ensuring sufficient precision of the sensor assembly in order to guarantee all of the extrinsic and intrinsic tolerances for the field of view of the sensor. Moreover, difficulties can occur in the case of heat management, in particular as a result of the fact that an installation location on/under the vehicle roof is a very demanding assembly position with respect to heat development.

Installation location under the roof of the vehicle in a “beauty” cover which is part of the outer shell of the vehicle. The disclsoure describes the structure and the assembly of a lidar sensor within a cover which is to later be assembled on the body.

Modern lidar sensors or LiDAR (Light Detecting and Ranging) sensors are frequently deployed in vehicles for detecting objects or capturing the surroundings. The lidar sensor is based on the functional principle that the latter emits rays of light or laser pulses which are then backscattered or reflected by objects, wherein the backscattered light is subsequently detected by the lidar sensor. For example, the distance from the respective object can then be calculated or determined from the captured Time of Flight (ToF) of the signals. Such lidar sensors are increasingly being utilized in driver assistance systems which are, inter alia, provided to warn and/or to support the driver in critical situations (e.g., with braking or steering interventions). In this case, the current progress of the technology also increasingly allows the deployment of coherent laser sensor technology in distance measurement. In addition to measuring distances, said technology also allows the current difference in speed between the sensor and the measured object to be determined.

A roof module for forming a vehicle roof on a motor vehicle, which has a panel member, the outer surface of which at least partially forms the roof skin of the vehicle roof, is known from DE 10 2021 115 340 B4. Furthermore, a sensor module is provided, which comprises at least one environment sensor for capturing the vehicle surroundings and a housing (or sensor housing). The sensor housing is arranged on a carrier member of the sensor module, with which the sensor module is rotatably mounted about an axis of rotation, so that it can be retracted and extended in an opening in the panel member of the roof module.

A fastening device for fastening a lidar sensor in a vehicle is known from DE 10 2023 002 488 A1, which fastening device has a holding frame with four eyelets, which each have angle elements in at least two places on an upper side, wherein a retaining element is pushed into the respective eyelet, which retaining element consists of a screw receptacle made of metal and a damping element made of natural rubber which is connected by vulcanization to the screw receptacle. The damping element has two wings which are each configured in the form of a right-angled triangle and which, after the retaining element has been pushed into the eyelet, engage in the respective angle element of the eyelet.

Furthermore, WO 2021 032 597 A2 describes a roof module for forming a vehicle roof on a motor vehicle, having a panel member, the outer surface of which at least partially forms the roof skin of the vehicle roof, wherein the roof module comprises at least one environment sensor for capturing the vehicle surroundings. The panel member consists of a material which is impermeable to the electromagnetic signals of the environment sensor. In addition, the panel member has at least one cutout through which the electromagnetic signals of the environment sensor can pass.

In addition, sensor arrangements are also known from DE 10 2018 113 383 A1, DE 10 2020 209 929 A1 and DE 10 2018 216 426 A1, in which a lidar sensor is assembled on the vehicle roof of a vehicle.

It is therefore desirable to provide a sensor arrangement which can be assembled and dismantled easily and cost-effectively, and with which a precise assembly of the sensor on the vehicle roof and the accurate alignment thereof can be guaranteed. In addition, other desirable features and characteristics will become apparent from the subsequent summary and detailed description, and the appended claims, taken in conjunction with the accompanying drawings and this background.

### SUMMARY

In one embodiment, a sensor arrangement for capturing the surroundings for a vehicle includes a sensor for capturing the surroundings. Such a sensor may be an optical sensor such as a camera or a lidar sensor. However, it would also be conceivable to deploy other sensors which transmit electromagnetic waves such as radar or ultrasound. The sensor for capturing the surroundings has a sensor housing. An arrangement housing is provided, in which the sensor is arranged, wherein the arrangement housing is arranged in/on a vehicle roof of the vehicle. A fastening device which has a first portion having a first diameter and a second portion having a second diameter is provided on the sensor housing of the sensor or lidar sensor, wherein the first diameter is smaller than the second diameter. In addition, the vehicle has at least one receptacle for the fastening device which is embodied such that the latter can receive a portion having the first diameter and cannot receive a portion having the second diameter, so that the fastening apparatus engages with the first portion in the receptacle and the second portion does not engage in the receptacle in order to align the sensor on the vehicle.

According to one embodiment, one or more threaded bolts or bolts or screw(s) or rivet(s) or pin(s) can be provided as the fastening device. These can be configured particularly well with corresponding first and second portions and can be produced simply.

The arrangement housing can expediently comprise a recess behind which the sensor is arranged.

Furthermore, a cover, in particular a lidome or the lidome front cover or a (lidome) front window can be arranged in/on the recess, which is permeable to signals, e.g., the laser beams or rays of light which are emitted by the lidar sensor, of the sensor.

A first sealing element may be expediently provided, which is arranged between the sensor housing and the arrangement housing and surrounds the recess and is configured in one piece or multiple pieces. As a result, the tightness of the sensor arrangement and also the retention inside the arrangement housing are improved to a particular extent.

A second sealing element is provided, which is arranged between the arrangement housing and the vehicle, in particular the vehicle roof. In particular, the tightness or watertightness and dust-tightness is/are additionally improved by the combination of the first and second sealing elements.

A 2C seal (two-component injection molding) may be provided as the first sealing element and/or as the second sealing element, or a curing adhesive seal or a rubber seal, e.g., a wet adhesive can be applied, which can be pre-cured and then turns into a rubber-like, compressible seal (e.g., a so-called cure-in-place gasket). Furthermore, a simple plastic seal can also be provided.

At least one tongue can be expediently provided on the sensor housing and at least one slot can be provided on the arrangement housing, wherein the sensor housing can be inserted in the arrangement housing by introducing the tongue of the sensor housing into the slot of the arrangement housing.

According to one embodiment, the fastening device can be additionally fixed, in particular screwed, riveted or clamped, in the receptacle. As a result, the strength, durability and tightness are additionally improved and the positioning in the end location is further fixed.

The arrangement housing can be expediently fastened to the vehicle by a connection comprising a hole, in particular a through-bore, wherein the diameter of the hole is larger than the diameter of a bore or through-bore of the receptacle. As a result, the alignment and adjustment are additionally simplified and improved.

Alignment bushes or aligning bushes may be provided on the sensor housing and/or on the arrangement housing, in which alignment pins or aligning pins of the sensor housing and/or arrangement housing fit, wherein the sensor housing and arrangement housing are arranged on one another and aligned by the aligning pins engaging in the aligning bushes and preferably being secured therein.

A vehicle which includes a sensor arrangement described herein is also disclosed.

Furthermore, the disclosure provides a method for assembling a sensor arrangement. The method includes inserting the sensor, for example a lidar sensor, into an inner side of the arrangement housing. This insertion may be achieved by introducing the tongue/tongues of the sensor into the slot/slots of the arrangement housing, aligning and fastening the sensor housing inside the arrangement housing and arranging the arrangement housing in/on the vehicle or vehicle roof by introducing the fastening apparatus(es) of the sensor housing into the receptacle(s) of the vehicle.

Furthermore, the method can expediently comprise a method step, in which the fastening apparatus is fixed or fastened in the receptacle, e.g., by firmly screwing, firmly riveting, firmly clamping or otherwise securing said fastening apparatus in the receptacle.

In summary, the disclosure provides a clear and simple sequence for the assembly of the sensor arrangement. The disclosure shows how the sensor can be sealed against the external surroundings and how the sensor can be exchanged in the event of a repair. The disclosure provides an overview of various sealing concepts which can be utilized in combination with the design. The disclosure makes possible a precise alignment method of the sensor on the body, avoiding overstressing. In addition, the disclosure describes the structure and the assembly of the sensor and of the cover or of the arrangement housing on the body/vehicle compartment. The disclosure makes possible a complete reversible dismantling of the components without damaging them. The disclosure shows a design and assembly concept which can provide compression forces from two directions offset at right angles at the same time (pressure direction of lidome front window and cover can be displaced by 45°-135° in the spatial angle). The advantages of the disclosure include a simple and cost-effective assembly process of the sensor and the cover on the body or on the vehicle roof is provided. The disclosure combines a watertight sealing concept with a complete repair concept (exchange of the sensor in a workshop). Thanks to the precise assembly and alignment of the sensor, extrinsic tolerances are reduced and the repercussions on the field of view are reduced. In addition, a complete reversible dismantling is guaranteed, which avoids damage to individual components during repair work.

### BRIEF DESCRIPTION OF THE DRAWINGS

The disclosed subject matter is explained in greater detail below with reference to expedient exemplary embodiments, wherein:

FIG. 1 shows a simplified representation of a configuration of a sensor arrangement;

FIG. 2 shows a simplified representation of the lidar sensor of the sensor arrangement from FIG. 1;

FIG. 3 shows a simplified representation of the arrangement housing of the sensor arrangement from FIG. 1;

FIG. 4 shows a simplified schematic representation of a lidar sensor of a sensor arrangement;

FIG. 5 shows a simplified schematic representation of a configuration of a part of a vehicle roof, which is provided for the installation of a sensor arrangement and which has been correspondingly prepared to this end according to a configuration;

FIG. 6 shows a simplified schematic representation of a configuration of a part of a vehicle having a sensor arrangement, and

FIGS. 7A-C show a simplified schematic representation of assembly steps of a sensor arrangement, wherein FIG. 7A shows the insertion of a lidar sensor in an inner side of the arrangement housing, FIG. 7B shows the alignment of the lidar sensor by introducing the tongues of the sensor into slots of the arrangement housing and FIG. 7C shows the fastening of the sensor housing inside the arrangement housing.

### DETAILED DESCRIPTION

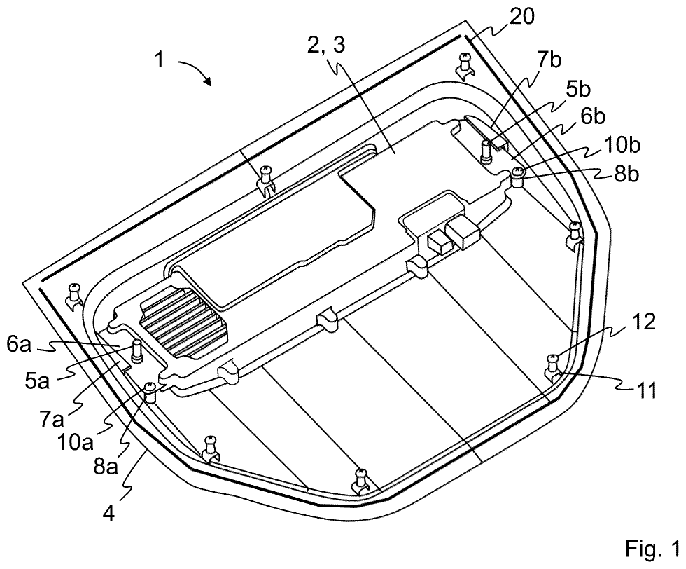

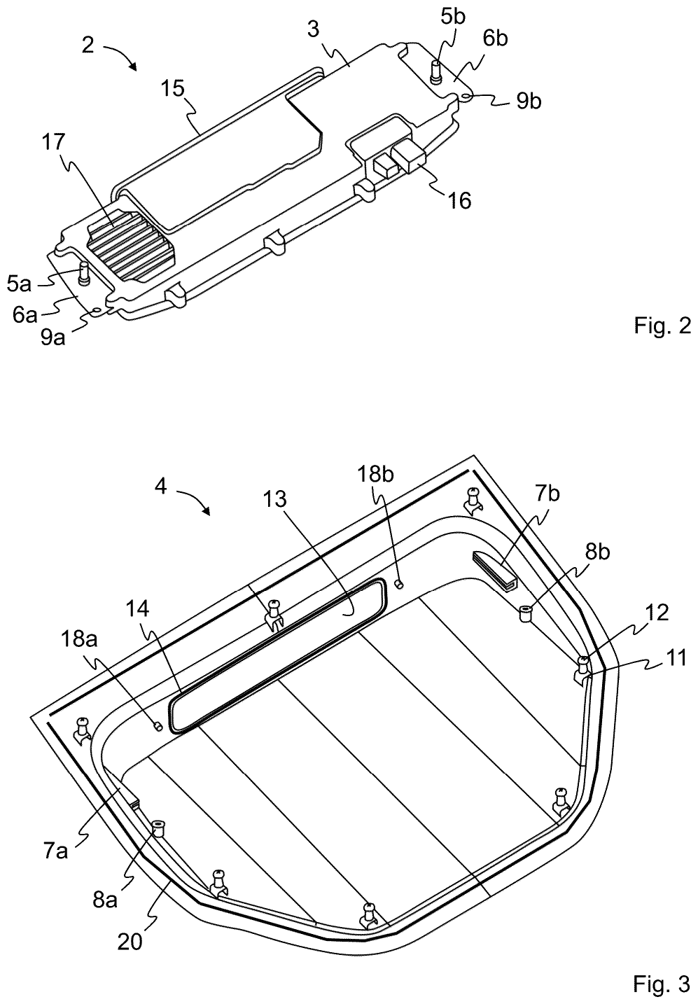

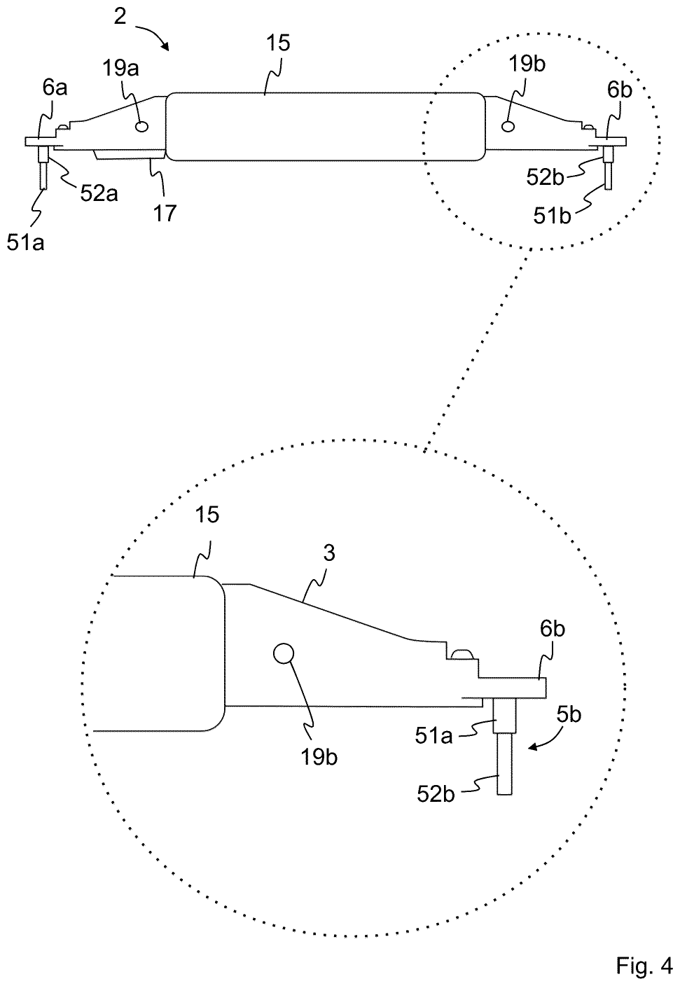

Reference numeral 1 in FIG. 1 designates a sensor arrangement for a vehicle according on an exemplary embodiment. The sensor arrangement 1 includes a lidar sensor 2 for capturing the surroundings, which has a sensor housing 3 and is accommodated in an arrangement housing 4. The sensor arrangement 1 can be mounted with the arrangement housing 4 on the vehicle or on the vehicle body or the vehicle roof. For the sake of simplicity, the sensor housing 3 and the arrangement housing 4 are again depicted separately in FIG. 2 and FIG. 3.

The sensor housing 3 of the lidar sensor 2 includes a fastening device or one or more bolts 5a, 5b (or a pair of or multiple threaded bolts), which make(s) it possible to precisely align the lidar sensor 2 on the body of the vehicle with the aid of an exactly rotated diameter. During the production (e.g., by means of die casting or in some other way) of the sensor housing 3, the bolts 5 can be mounted directly on said sensor housing. Alternatively, the bolt can also be mounted by being pressed into or welded onto the sensor housing 3. Alternatively or additionally, the bolt can also be mounted on, e.g., screwed on, the sensor housing 3 by means of other solutions. Furthermore, the sensor housing 3 includes in each case, on at least two sides, a tongue 6a, 6b which can be plugged or pushed into a slot 7a, 7b or a pocket of the arrangement housing 4 (or lid) in order to provide additional retention and guidance during the assembly process. In addition, the arrangement housing 4 may also include bushes or threaded bushes 8a, 8b, wherein screws 10a, 10b are provided, which engage in the threaded bushes 8a, 8b or are screwed into the latter, through bores 9a, 9b in the sensor housing 3 or the tongues 6a, 6b, in order to additionally hold the sensor housing 3 in the end position in the arrangement housing 4. In addition, the arrangement housing 4 includes threaded bushes 11 into which screws 12 can be screwed from the lower side (or from the vehicle roof side) in order to screw the arrangement housing 4 onto the vehicle or onto the vehicle body or the vehicle roof. Alternatively, e.g., self-tapping screws may also be used, which can be screwed directly in the arrangement housing 4 and would therefore render threaded bushes 11 superfluous (however, the self-tapping screws could of course also engage in corresponding bushes, projections or the like). Instead of the indicated screw connections, other types of connection such as, e.g., rivets, clamps or the like may of course also be provided.

In addition, the arrangement housing 4 has an opening or recess 13, through which a sensor view is guaranteed, and includes at least one sealing element 14 surrounding or enclosing the recess 13, wherein said sealing element 14 or seal ensures the tightness around a lidome front window 15 of the lidar sensor 2 and can be referred to as a lidome seal. The sealing element 14 can be formed in one part or multiple parts. The sealing element 14 is part of the arrangement housing 4 and can be configured as a 2C seal (two-component injection molding). An alternative includes applying a wet adhesive in the region of the sealing, which can be pre-cured when exposed to UV light or thermal heat or the like and then turns, e.g., into a rubber-like seal (in particular, cure-in-place gasket). The compression force in order to guarantee watertightness is ensured, e.g., through the screw connection by means of screws 10a, 10b (in particular, these can also be self-tapering screws) which may be fastened to the arrangement housing 4 at each tongue 6a, 6b.

Moreover, the lidar sensor 2 also includes other components such as, e.g., a connection unit 16 in order to couple the lidar sensor 2 electrically and/or electronically to other members (e.g., a control device of the vehicle), and a cooling unit 17 (e.g., cooling ribs, fan or the like) in order to cool the lidar sensor.

Furthermore, two alignment pins 18a, 18b, which fit into aligning bushes 19a, 19b of the arrangement housing 4, are located on the front side of the sensor housing 3 (similarly, the alignment pins which fit or engage in alignment bushes of the sensor housing 3 could, of course, also be provided on the arrangement housing 4). Thanks to the additional fastening, the lidar sensor 2 is precisely positioned and aligned with respect to the arrangement housing 4. Furthermore, a second sealing element 20 is provided, which seals the arrangement housing 4 with respect to the vehicle roof. The second seal or sealing element 20 (lid sealing or lid seal) is located around the outer edges of the arrangement housing 4. The sealing element 20 may also be part of the arrangement housing 4 and can be configured as a 2C seal (2-component injection molding) or is applied as a wet adhesive which can be pre-cured and then turns into a rubber-like seal (cure-in-place gasket). The pressing force in order to guarantee watertightness is also provided here, e.g., by the (if necessary, self-tapering) screws 12 which can be fastened, for example, through holes of the body from the vehicle interior.

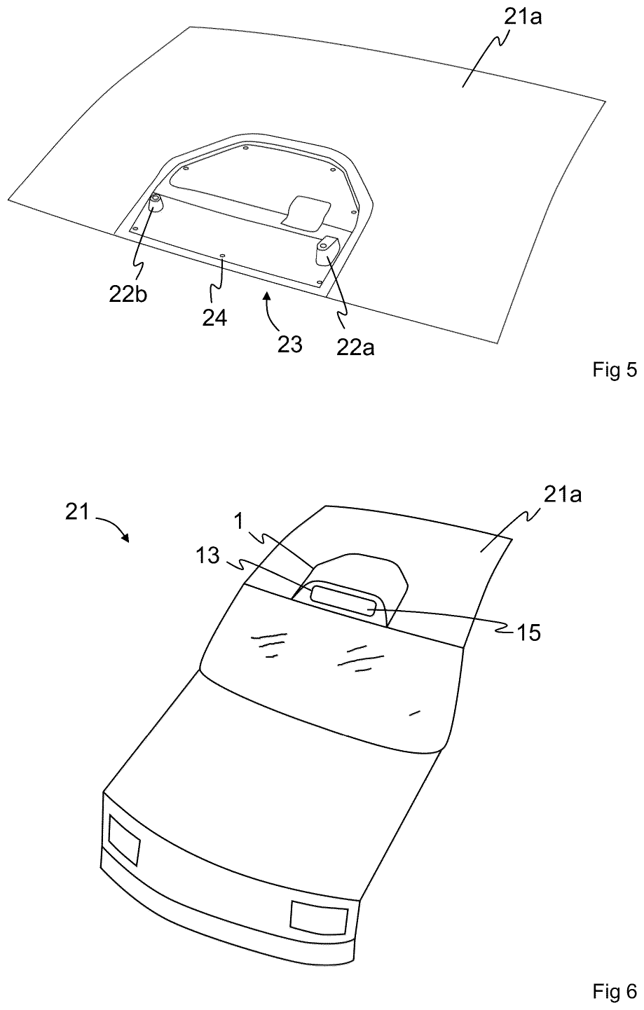

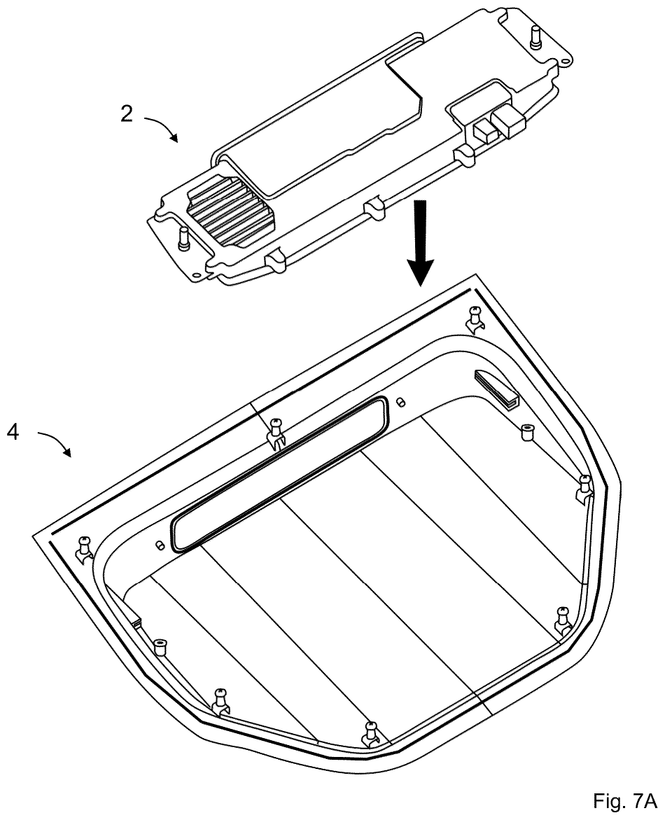

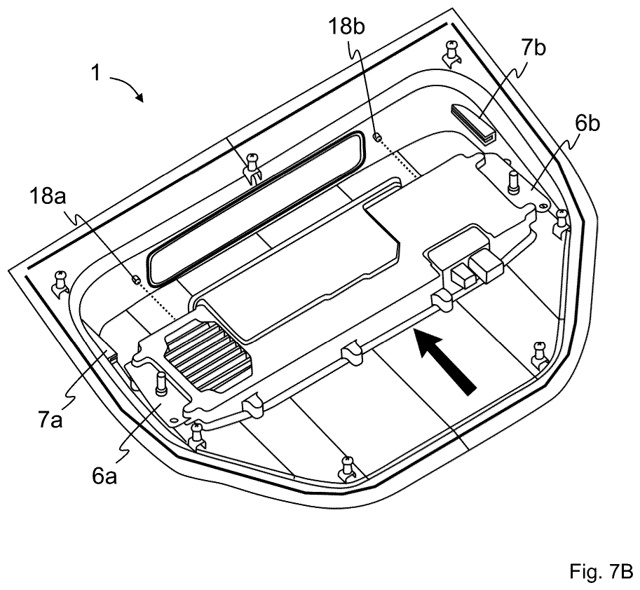

Furthermore, the fastening device has, or the bolts 5a, 5b each have, a first portion 51a, 51b having a first diameter and a second portion 52a, 52b having a second diameter, as shown in FIG. 4. In this case, the first diameter is smaller than the second diameter, i.e., the first portion 51a, 51b has a smaller thickness than the second portion 52a, 52b. To this end, the vehicle 21 having the vehicle roof 21a is shown in FIG. 5 and FIG. 6, in which receptacles 22a, 22b are provided and which has a corresponding recess or preparation (optionally: sensor arrangement place 23 having through-bores 24) for the sensor arrangement 1. The receptacles 22a, 22b of the vehicle 21 are embodied such that the latter can receive the portion 51a, 51b having the first diameter and cannot receive the portion 52a, 52b having the second diameter, so that the bolts 5a, 5b each engage with the first portion 51a, 51b in the receptacles 22a, 22b and the second portion 52a, 52b does not engage in the receptacles 22a, 22b, as a result of which the second portions 52a, 52b sit, so to speak, on the receptacles 22a, 22b, and the sensor is consequently aligned on the vehicle 21 or vehicle roof.

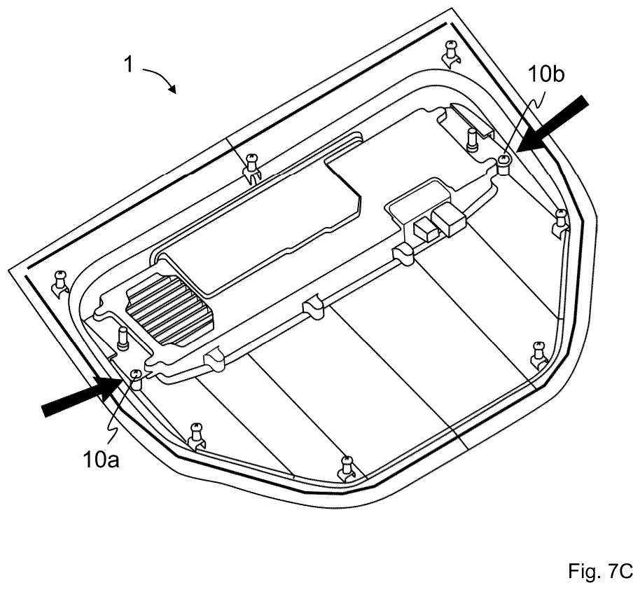

The assembly process of the sensor arrangement 1 may be carried out in multiple steps, wherein the sensor or lidar sensor 2 is initially inserted in an inner side or inside the arrangement housing 4, as shown by the black arrow in FIG. 7A. Furthermore, the tongue(s) 6 of the lidar sensor 2 can then be introduced into the slot(s) 7 of the arrangement housing 4 by pushing the sensor forward onto the front side of the arrangement housing 4 in a further step, as a result of which the envisaged end location of the lidar sensor 2 in the arrangement housing 4 is achieved, as shown in FIG. 7B with the help of the black arrow. In this case, a determined compression force can also be applied to the lidar sensor 2 which specifies the position of the lidar sensor 2 and aligns the latter at the same time, e.g., with the aid of a pin-bush system (comprising alignment pins 18a, 18b and complementary alignment bushes 19a, 19b on the arrangement housing 4), on the front side of the sensor housing 3 and the inner side of the arrangement housing 4. Furthermore, e.g., the screws 10a, 10b are then located or firmly screwed, which fix the position between the lidar sensor 2 and the arrangement housing 4 and ensure that the deformable seal 14 is deformed around the lidome or the lidome front window 15. Ultimately, a lidar sensor 2 pre-assembled in the arrangement housing 4 is then provided, which is then introduced in an end assembly onto/into the body of the vehicle 21 or of the vehicle roof 21. To do this, the two bolts 5a, 5b are initially plugged into the receptacles 22a, 22b or drill holes or slots of the body, as a result of which the lidar sensor 2 is aligned, in that a first segment or the first portion 51a, 51b of the bolt 5a, 5b having the first smaller diameter engages in the receptacle 22a, 22b and the second segment or the second portion 52a, 52b of the bolt 5a, 5b does not engage in the receptacle 22a, 22b since the latter has a second larger diameter. The second portion 52a, 52b may terminate flush with the respective receptacle 22a, 22b. Furthermore, the bolts 5a, 5b can also be additionally fastened or secured or fixed in the receptacle 22a, 22b by, e.g., screwing a screw nut coming from the vehicle interior onto the latter (to this end, the first portion 51a, 51b can have, for example, a thread) and consequently fixing or locking the latter in the end position. Alternatively or additionally, a clamping or pressing connection or the like could also be provided to additionally fasten the bolt 5a, 5b or the first portion 51a, 51b in the receptacle 22a, 22b. As a result, the sensor is precisely aligned including all the extrinsic and intrinsic tolerances for the field of view. Thereafter, the screws 12 for the arrangement housing 4 can be fastened, e.g., from the interior of the vehicle 21, so that the compression force can be provided for sealing the lid seal or sealing element 20. The through-bores 24 for the (lid) screws 14 may be rather larger than the receptacle 22a, 22b or alignment bores in the receptacle 22a, 22b for the bolt(s) 5, in order to guarantee a tolerance compensation of the displacement which can occur due to deviations from part to part (due to manufacturing tolerances).

Of course, all of the assembly steps may also be utilized in reverse so that a complete dismantling of all of the components can be performed and each component can be exchanged for repair in the workshop. The method is in particular also characterized in that none of the components is damaged by the dismantling and can potentially be reused. Furthermore, there is the option that parts of the bottom of the metal housing can come into contact with/touch the body/the sheet metal in order to increase the thermal heat dissipation (cooling). Optionally, a certain air gap can be present between the sensor housing 3 and body in order to guarantee a better air circulation for natural or forced convection. The application depends on the thermal conditions which can prevail individually in the respective installation location on the vehicle 21.

1. A sensor arrangement for capturing the surroundings of a vehicle, comprising:
a sensor for capturing the surroundings having a sensor housing;
an arrangement housing in which the sensor is arranged;
wherein the arrangement housing is arranged in/on a vehicle roof of the vehicle; and
a fastening device disposed on the sensor housing and including a first portion having a first diameter and a second portion having a second diameter, wherein the first diameter is smaller than the second diameter; and
the vehicle defines at least one receptacle which can receive the first portion having the first diameter but cannot receive the second portion having the second diameter such that the fastening apparatus engages with the first portion in the receptacle and the second portion does not engage in the receptacle in order to align the sensor on the vehicle.

2. The sensor arrangement according to claim 1, wherein the arrangement housing defines a recess behind which the sensor is arranged.

3. The sensor arrangement according to claim 2, further comprising a cover disposed in the recess, the cover being permeable to signals of the sensor.

4. The sensor arrangement according to claim 3, further comprising a first sealing element arranged between the sensor housing and the arrangement housing and surrounding the recess.

5. The sensor arrangement according to claim 4, further comprising a second sealing element arranged between the arrangement housing and the vehicle.

6. The sensor arrangement according to claim 5, wherein at least one of the sealing elements includes a 2C seal.

7. The sensor arrangement according to claim 1, further comprising at least one tongue provided on the sensor housing and at least one slot defined by the arrangement housing, wherein the sensor housing is inserted in the arrangement housing by introducing the tongue of the sensor housing into the slot of the arrangement housing.

8. The sensor arrangement according to claim 1, wherein the fastening device is fixed in the receptacle.

9. The sensor arrangement according to claim 1, wherein the arrangement housing is fastened to the vehicle by a connection comprising a through-bore hole, wherein the diameter of the hole is larger than the diameter of a bore of the receptacle.

10. The sensor arrangement according to claim 1, further comprising aligning bushes disposed on at least one of the sensor housing and the arrangement housing, and accommodating aligning pins, wherein the sensor housing and the arrangement housing are arranged on one another and aligned by the aligning pins engaging in the aligning bushes and being secured therein.

11. A vehicle comprising:
a roof;
a sensor arrangement, including
a sensor for capturing the surroundings, the sensor having a sensor housing,
an arrangement housing in which the sensor is arranged, and disposed on the roof, and
a fastening device disposed on the sensor housing and including a first portion having a first diameter and a second portion having a second diameter, wherein the first diameter is smaller than the second diameter; and
wherein the vehicle defines at least one receptacle which can receive the first portion having the first diameter but cannot receive the second portion having the second diameter such that the fastening apparatus engages with the first portion in the receptacle and the second portion does not engage in the receptacle in order to align the sensor on the vehicle.

12. A method for assembling a sensor arrangement of a vehicle, the sensor arrangement including a sensor having a sensor housing having a tongue, an arrangement housing in a roof of the vehicle, the arrangement housing defining a slot, a fastening device disposed on the sensor housing and including a first portion having a first diameter and a second portion having a second diameter, wherein the first diameter is smaller than the second diameter, the vehicle defining at least one receptacle which can receive the first portion having the first diameter but cannot receive the second portion having the second diameter such that the fastening apparatus engages with the first portion in the receptacle and the second portion does not engage in the receptacle in order to align the sensor on the vehicle, the method comprising:
inserting the sensor into an inner side of the arrangement housing by introducing the tongue of the sensor into the slot of the arrangement housing,
aligning and fastening the sensor housing inside the arrangement housing,
arranging the arrangement housing on the vehicle by introducing the fastening apparatus of the sensor housing into the receptacle of the vehicle.

13. The method according to claim 12, further comprising fastening the fastening apparatus in the receptacle.
